(19) United States
(12) Patent Application Publication
(10) Pub. No.: US 2025/0225664 A1
(43) Pub. Date: Jul. 10, 2025

(54) METHOD AND APPARATUS FOR STITCHING FRAMES OF IMAGE COMPRISING MOVING OBJECTS

(71) Applicant: Samsung Electronics Co., Ltd., Suwon-si (KR)

(72) Inventors: Vikas KUMAR, Noida (IN); Himanshu SHARMA, Noida (IN); Gopal KUMAR, Noida (IN); Shubham KUMAR, Noida (IN)

(21) Appl. No.: 19/096,007

(22) Filed: Mar. 31, 2025

Related U.S. Application Data
(63) Continuation of application No. PCT/KR2022/020514, filed on Dec. 15, 2022.

(30) Foreign Application Priority Data
Oct. 29, 2022 (IN) 202211061694

(51) Int. Cl. G06T 7/246; G06T 3/4038; G06T 7/00; G06T 7/33; G06T 7/90

(52) U.S. Cl. CPC G06T 7/248; G06T 3/4038; G06T 7/0002; G06T 7/337; G06T 7/90; G06T 2207/10024; G06T 2207/20081; G06T 2207/30168; G06T 2207/30241

(57) ABSTRACT

A method for generating a stitched image by an electronic device is disclosed. The method comprises: identifying a moving object from a first frame and a second frame among a plurality of frames; normalizing the attributes associated with the moving object from overlapping region of the first frame and the second frame with respect to image capturing device attributes; determining a trajectory, associated with the moving object based on the normalized attributes; stitching the first frame at a first location of the overlapping region where the moving object is present, or stitching the first frame at a second location of the overlapping region where the moving object is not present, wherein the trajectory from the first frame is masked to regenerate a masked portion of the second frame; and generating the stitched image by stitching the first frame with the masked portion of the second frame.

### CROSS-REFERENCE TO RELATED APPLICATIONS

This application is a continuation of International Application No. PCT/KR2022/020514 designating the United States, filed on Dec. 15, 2022, in the Korean Intellectual Property Receiving Office and claiming priority to Indian Patent Application number 202211061694, filed on Oct. 29, 2022, in the Indian Patent Office, the disclosures of each of which are incorporated by reference herein in their entireties.

### BACKGROUND

### Field

The disclosure relates to generating a stitched image in a panoramic view, and relates to a method and a apparatus for generating the stitched image by stitching frames of an image comprising one or more moving objects.

### Description of Related Art

In existing systems for creating a panoramic image moving objects are identified so that image stitching can be correctly done for generating aligned image. Since there are overlapping reasons for moving object in various frames, that leads issue in image stitching. Since a moving object appears across overlapping regions, while capturing panorama, moving objects in the panorama image cannot be produced with a motion effect, hence a Panoramic image has been still in nature.

The panorama is wide-angle view of photography. Multiple frames covering wide angle depending on continuous frames captured for wide view, stitching captured frames to make a single shot. Available Panoramic solutions are static e.g. static background or still view.

Currently, the panorama mode includes a number of issues such as, generated panorama image shows all objects as static whereas a real life view may have few objects in motion, and a frame stitching leads to blurriness for the moving object.

Proper panorama image is not generated when captured frames have moving objects, reasons for failure include that moving object trajectory or overlapping region is not followed, at the same time masking and recreating of trajectory path is not done, and stitching of frames while a phone is in motion to capture panoramic image is not adjusted based on the motion of moving object appearing across multiple frames.

A conventional solution discloses a method for stitching of multiple frames to form a wide view static image (static panorama). All objects whether static or dynamic are shown as static in final image generated

Another conventional solution discloses a method for providing information and improving the quality of digital entertainment by a panoramic video as a counterpart of the image stitching. However, this solution also does not support to show moving objects as objects in motion.

Drawbacks with the conventional solutions include moving object trajectory or overlapping region not being followed, at the same time masking and recreating of trajectory path is not done, if more than one objects are presents and moving towards on another, they are unable to handle to produce liveness in image, and stitching of frames while a phone is in motion to capture panoramic image is not adjusted based on the motion of moving object appearing across multiple frames.

There is a need to address the above-mentioned drawbacks.

### SUMMARY

According to an example embodiment of the present disclosure, a method for generating a stitched image by an electronic device is disclosed. The method may comprise: obtaining an input stream including a plurality of frames through an image capturing device; identifying one or more moving objects and one or more timestamps associated with movement of the one or more moving objects from a first frame and a second frame selected among the plurality of frames; determining a plurality of attributes associated with the one or more moving objects from at least one overlapping region of the first frame and the second frame; normalizing the determined plurality of attributes with respect to a plurality of device attributes associated with the image capturing device; determining a trajectory, associated with the one or more moving objects and a moving region of the one or more moving objects in the first frame and the second frame based on the normalized plurality of attributes; performing one of stitching the first frame at a first location of the at least one overlapping region where the one or more moving objects are present, wherein the trajectory from the first frame is masked to regenerate a masked portion of the second frame, and stitching the first frame at a second location of the at least one overlapping region where the one or more moving objects are not present, wherein the trajectory from the first frame is masked to regenerate a masked portion of the second frame; and generating the stitched image by stitching the first frame with the masked portion of the second frame.

According to an example embodiment of the present disclosure, an electronic device for generating a stitched image is disclosed. The electronic device may comprise a memory; and at least one processor, comprising processing circuitry, coupled to the memory, wherein at least one processor, individually and/or collectively, may be configured to: obtain an input stream including a plurality of frames through an image capturing device; identify one or more moving objects and one or more timestamps associated with movement of the one or more moving objects from a first frame and a second frame selected among the plurality of frames; determine a plurality of attributes associated with the one or more moving objects from at least one overlapping region of the first frame and the second frame; normalize the determined plurality of attributes with respect to a plurality of device attributes associated with the image capturing device; determine a trajectory, associated with the one or more moving objects and a moving region of the one or more moving objects in the first frame and the second frame based on the normalized plurality of attributes; perform one of stitching the first frame at a first location of the at least one overlapping region where the one or more moving objects are present, wherein the trajectory from the first frame is masked to regenerate a masked portion of the second frame, and stitching the first frame at a second location of the at least one overlapping region where the one or more moving objects are not present, wherein the trajectory from the first frame is masked to regenerate a masked portion of the second frame; and generate the stitched image by stitching the first frame with the masked portion of the second frame.

According to an example embodiment of the present disclosure, a non-transitory computer readable storage medium storing instructions is disclosed. The instructions, when executed by at least one processor, individually and/or collectively, of an electronic device, cause the electronic device to perform operations comprising: obtaining an input stream including a plurality of frames through an image capturing device; identifying one or more moving objects and one or more timestamps associated with movement of the one or more moving objects from a first frame and a second frame selected among the plurality of frames; determining a plurality of attributes associated with the one or more moving objects from at least one overlapping region of the first frame and the second frame; normalizing the determined plurality of attributes with respect to a plurality of device attributes associated with the image capturing device; determining a trajectory, associated with the one or more moving objects and a moving region of the one or more moving objects in the first frame and the second frame based on the normalized plurality of attributes; performing one of stitching the first frame at a first location of the at least one overlapping region where the one or more moving objects are present, wherein the trajectory from the first frame is masked to regenerate a masked portion of the second frame, and stitching the first frame at a second location of the at least one overlapping region where the one or more moving objects are not present, wherein the trajectory from the first frame is masked to regenerate a masked portion of the second frame; and generating the stitched image by stitching the first frame with the masked portion of the second frame.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a flowchart illustrating an example method for generating a stitched image by stitching frames of an image comprising one or more moving objects, according to various embodiments;

FIG. 2 is a block diagram illustrating an example configuration of a system configured to generate a stitched image by stitching frames of an image comprising one or more moving objects, according to various embodiments;

FIG. 3 is a flowchart illustrating an example process for generating a stitched image by stitching frames of an image comprising one or more moving objects, according to various embodiments;

FIG. 4 is a diagram illustrating an example method for generating a stitched image by stitching frames of an image comprising one or more moving objects, according to various embodiments;

FIG. 5A is a diagram illustrating an example method for selecting a first frame and a second frame from a number of frames, according to various embodiments;

FIG. 5B is a diagram illustrating an example process for selecting the first frame and the second frame from the number of frames, according to various embodiments;

FIG. 5C is a diagram illustrating an example first stage and second stage for selecting the first frame and the second frame, according to various embodiments;

FIG. 6 is a diagram illustrating an example process for identifying one or more moving objects in a plurality of frames, according to various embodiments;

FIG. 7 is a flowchart illustrating an example process for determining a plurality of attributes of one or more moving objects, according to various embodiments;

FIG. 8 is a flowchart illustrating an example process for tracing a path of one or more moving objects, according to various embodiments; and

FIG. 9 is a diagram illustrating example trajectory generation, according to various embodiments.

Those skilled in the art will appreciate that elements in the drawings are illustrated for simplicity and may not have been necessarily drawn to scale. For example, the flowcharts illustrate the method in terms of operations involved to help to improve understanding of aspects of the present disclosure. Furthermore, in terms of the construction of the device, one or more components of the device may have been represented in the drawings by conventional symbols, and the drawings may show various details that are pertinent to understanding the various embodiments of the present disclosure so as not to obscure the drawings with details that will be readily apparent to those of ordinary skill in the art having benefit of the description herein.

### DETAILED DESCRIPTION

Reference will now be made to various example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory and are not intended to be restrictive.

Reference throughout this disclosure to “an aspect”, “another aspect” or similar language refers, for example, to a particular feature, structure, or characteristic described in connection with the various embodiments being included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which the disclosure belongs. The system, methods, and examples provided herein are illustrative only and not intended to be limiting.

Various example embodiments of the present disclosure are described below in greater detail with reference to the accompanying drawings.

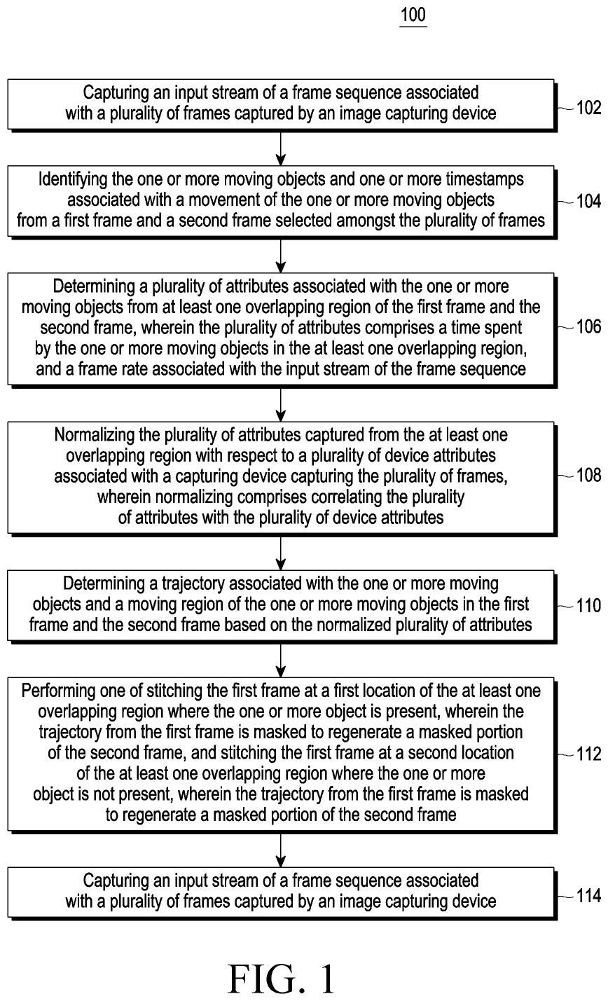

FIG. 1 is a flowchart illustrating an example method 100 for generating a stitched image by stitching frames of an image comprising one or more moving objects, according to various embodiments. The method 100 may be implemented in an electronic device. Examples of the electronic device may include, but are not limited to, a smartphone, a laptop, a Personal Computer (PC), and a tablet. The image and the stitched image may be in a panorama mode.

At operation 102, the method 100 includes capturing an input stream of a frame sequence associated with a plurality of frames by an image capturing device.

At operation 104, the method 100 includes identifying the one or more moving objects and one or more timestamps associated with a movement of the one or more moving objects from a first frame and a second frame selected amongst the plurality of frames.

At operation 106, the method 100 includes determining a plurality of attributes associated with the one or more moving objects from at least one overlapping region of the first frame and the second frame, wherein the plurality of attributes comprises a time spent by the one or more moving objects in the at least one overlapping region, and a frame rate associated with the input stream of the frame sequence.

At operation 108, the method 100 includes normalizing the plurality of attributes captured from the at least one overlapping region with respect to a plurality of device attributes associated with a capturing device capturing the plurality of frames, wherein normalizing comprises correlating the plurality of attributes with the plurality of device attributes.

At operation 110, the method 100 includes determining a trajectory, associated with the one or more moving objects and a moving region of the one or more moving objects in the first frame and the second frame based on the normalized plurality of attributes.

At operation 112, the method 100 includes performing one of stitching the first frame at a first location of the at least one overlapping region where the one or more object is present, wherein the trajectory from the first frame is masked to regenerate a masked portion of the second frame, and stitching the first frame at a second location of the at least one overlapping region where the one or more object is not present, wherein the trajectory from the first frame is masked to regenerate a masked portion of the second frame.

At operation 114, the method 100 includes generating the stitched image by stitching the first frame with the masked portion of the second frame.

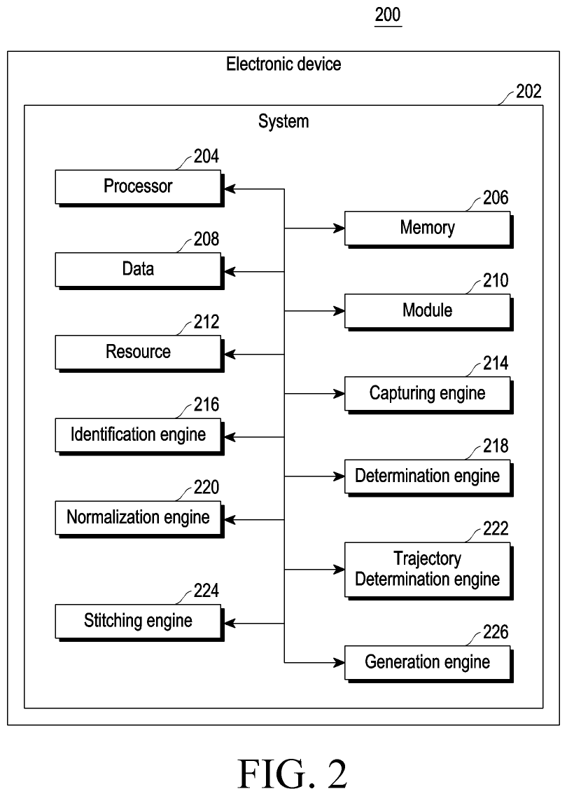

FIG. 2 is a block diagram 200 illustrating an example configuration of a system 202 configured to generate a stitched image by stitching frames of an image comprising one or more moving objects, according to various embodiments. The method 100 may be implemented in an electronic device. Examples of the electronic device may include, but are not limited to, a smartphone, a laptop, a Personal Computer (PC), and a tablet. The image and the stitched image may be in a panorama mode.

In an example embodiment, the system 202 can be a chip incorporated in the electronic device. In an example embodiment, the system 202 may be an implemented software, a logic-based program, a hardware, a configurable hardware, and the like. The system 202 includes a processor (e.g., including processing circuitry) 204, a memory 206, data 208, module(s) 210, resources(s) 212, a capturing engine 214, an identification engine 216, a determination engine 218, a normalization engine 220, a trajectory determination engine 222, a stitching engine 224, and a generation engine 226 each of the modules, resources and engines may include various circuitry and/or executable program instructions.

The processor 204, the memory 206, the data 208, the module(s) 210, the resources(s) 212, the capturing engine 214, the identification engine 216, the determination engine 218, the normalization engine 220, the trajectory determination engine 222, the stitching engine 224, and the generation engine 226 may be communicatively coupled to one another.

In an example, the processor 204 may include various processing circuitry and may include a single processing unit or a number of units, all of which could include multiple computing units. The processor 204 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 204 may be configured to fetch and/or execute computer-readable instructions and/or data stored in the memory 206. The processor 204 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an example, the memory 206 may include any non-transitory computer-readable medium known in the art including, for example, volatile memory, such as static random-access memory (SRAM) and/or dynamic random-access memory (DRAM), and/or non-volatile memory, such as read-only memory (ROM), erasable programmable ROM (EPROM), flash memory, hard disks, optical disks, and/or magnetic tapes. The memory 206 may include the data 208. The memory 206 may store instructions. When the instructions are executed by the processor 204, the instructions may cause the electronic device 200 or the processor to execute operations described herein.

The data 208 may serve, amongst other things, as a repository for storing data processed, received, and generated by one or more of the processor 204, the module(s) 210, the resources(s) 212, the capturing engine 214, the identification engine 216, the determination engine 218, the normalization engine 220, the trajectory determination engine 222, the stitching engine 224, and the generation engine 226.

The module(s) 210, amongst other things, may include routines, programs, objects, components, data structures, etc., which perform particular tasks or implement data types. The module(s) 210 may also be implemented as, signal processor(s), state machine(s), logic circuitries, and/or any other device or component that manipulate signals based on operational instructions.

Further, the module(s) 210 may be implemented in hardware, instructions executed by at least one processing unit, for e.g., processor 204, or by a combination thereof. The processing unit may be a general-purpose processor which executes instructions to cause the general-purpose processor to perform operations or, the processing unit may be dedicated to performing the required functions. In another aspect of the present disclosure, the module(s) 210 may be machine-readable instructions (software) which, when executed by a processor/processing unit, may perform any of the described functionalities.

In various example embodiments, the module(s) 210 may be machine-readable instructions (software) which, when executed by a processor/processing unit, perform any of the described functionalities.

The resource(s) 212 may be physical and/or virtual components of the system 202 that provide inherent capabilities and/or contribute towards the performance of the system 202. Examples of the resource(s) 212 may include, but are not limited to, a memory (e.g., the memory 206), a power unit (example, a battery), a display unit, etc. The resource(s) 212 may include a power unit/battery unit, a network unit, etc., in addition to the processor 204, and the memory 206.

Continuing with the above example embodiment, the capturing engine 214 may be configured to capture an input stream of a frame sequence. The frame sequence may be related to a number of frames captured by an image capturing device. Examples of the image capturing device may include, but are not limited to, a camera, smartphone, a video recorder, and a CCTV.

The identification engine 216 may be configured to identify the one or more moving objects and one or more timestamps associated with a movement of the one or more moving objects. The one or more moving objects and the one or more timestamps may be identified from a first frame and a second frame selected amongst the number of frames. For identifying the one or more moving objects, the identification engine 216 may be configured to compare a number of second frame grids of the second frame with a number of first frame grids of the first frame in terms of a pixel intensity. The pixel intensity is associated with the number of second frame grids and the number of first frame grids.

The identification engine 216 may be configured to determine that the pixel intensity associated with the number of second frame grids is not matching with the pixel intensity associated with the number of first frame grids. The identification engine 216 may also be configured to identify the one or more moving objects in the first frame and second frame based on the determination. The first frame may be a previous frame with respect to a current frame and the second frame may be the current frame. For selecting the first frame and the second frame, the identification engine 216 may be configured to perform a timestamp-based comparison of the number of frames with respect to a quality metric of each frame.

Each frame may be buffered with a timestamp associated with each of the number of frames. Further, the identification engine 216 may be configured to estimate a quality of each of the number of frames based on the timestamp-based comparison of the quality metric of each frame. The quality metric may be derived from a Power Spectral Density (PSD) of each frame. The identification engine 216 may be configured to select the first frame and the second frame amongst the number of frames based on the estimation.

For estimating the quality of each frame, the identification engine 216 may be configured to process the number of frames by applying a number of Machine Learning (ML) techniques. The identification engine 216 may be configured to calculate the PSD associated with each of the processed number of frames. The identification engine 216 may be configured to select at least two frames amongst the number of frames with the PSD greater than a predetermined threshold based on a density-based clustering and an outlier elimination. The at least two frames may include the first frame and the second frame. Each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The determination engine 218 may be configured to determine a number of attributes associated with the one or more moving objects from at least one overlapping region of the first frame and the second frame. The number of attributes may include a time spent by the one or more moving objects in the at least one overlapping region, and a frame rate associated with the input stream of the frame sequence.

The normalization engine 220 may be configured to normalize the number of attributes captured from the at least one overlapping region. Examples of the number of attributes may include, but are not limited to, one or more of a relative motion of the one or more moving objects, a ratio of swapping area of the one or more moving objects, a color of the one or more moving objects, a background color, a size of the one or more moving objects, a frame rate, a velocity of the one or more moving objects, and a time spent by the one or more moving objects in first frame. The normalization may be performed with respect to a number of device attributes associated with a capturing device capturing the number of frames. Examples of the number of device attributes may include, but are not limited to, one or more of a speed of the image capturing device, and a direction of a movement of the image capturing device. The normalization may include correlating the number of attributes with the number of device attributes. Further, correlating the number of attributes with the number of device attributes may include changing a value of one or more attributes amongst the number of attributes with respect to a value of the number of device attributes.

The trajectory determination engine 222 may be configured to determine a trajectory associated with the one or more moving objects and a moving region of the one or more moving objects in the first frame and the second frame based on the normalized number of attributes. For determining the trajectory, the trajectory determination engine 222 may be configured to determine that the number of attributes upon being normalized move the one or more moving objects. The trajectory determination engine 222 may be configured to detect a direction of motion of the one or more moving objects in the first frame and the second frame. The trajectory determination engine 222 may be configured to generate the trajectory based on a down sampling and up sampling of the number of attributes.

Accordingly, the stitching engine 224 may be configured to perform one of a number of stitching techniques. The number of stitching techniques may include stitching the first frame at a first location of the at least one overlapping region where the one or more object is present. The trajectory from the first frame is masked to regenerate a masked portion of the second frame. The number of stitching techniques may also include stitching the first frame at a second location of the at least one overlapping region where the one or more object is not present. The trajectory from the first frame may be masked to regenerate a masked portion of the second frame.

The generation engine 226 may be configured to generate the stitched image by stitching the first frame with the masked portion of the second frame.

The functions of the engines including the capturing engine 214, the identification engine 216, the determination engine 218, the normalization engine 220, the trajectory determination engine 222, the stitching engine 224, and the generation engine may be executed by the processor 204, in conjunction with the instructions which are for being executed by the processor and stored in the memory 206.

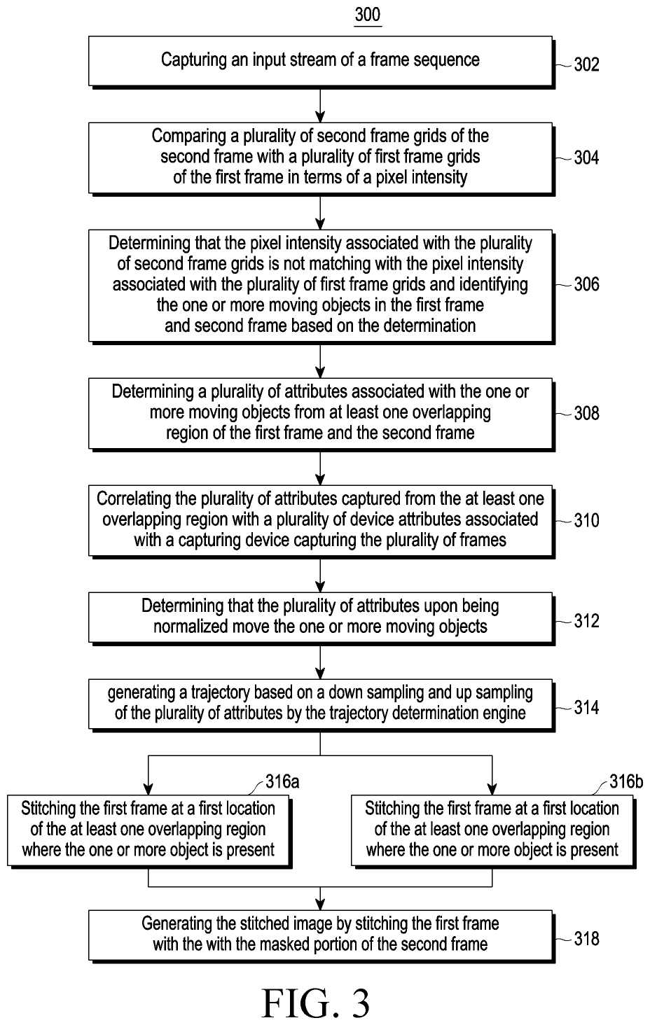

FIG. 3 is a flowchart illustrating an example process 300 for generating a stitched image by stitching frames of an image comprising one or more moving objects, according to various embodiments. The process may be performed by the system 202 incorporated in an electronic device of the user. Generating the stitched image may be based on applying one or more ML techniques. Examples of the one or more moving objects may include, but are not limited to, a human, an animal, and a vehicle.

At operation 302, the process 300 may include capturing an input stream of a frame sequence. The frame sequence may be related to a number of frames captured by an image capturing device. The input stream may be captured by the image capturing engine 214 as referred in FIG. 2. Further, the number of frames may be in panoramic view.

At operation 304, the process 300 may include comparing a number of second frame grids of the second frame with a number of first frame grids of the first frame in terms of a pixel intensity. The pixel intensity is associated with the number of second frame grids and the number of first frame grids. The comparison may be performed for identifying the one or more moving objects and one or more timestamps associated with a movement of the one or more moving objects. The identification may be performed by the identification engine 216 as referred in FIG. 2. The one or more moving objects and the one or more timestamps may be identified from a first frame and a second frame selected amongst the number of frames.

At operation 306, the process 300 may include determining that the pixel intensity associated with the number of second frame grids is not matching with the pixel intensity associated with the number of first frame grids and identifying the one or more moving objects in the first frame and second frame based on the determination. Further, the first frame may be a previous frame with respect to a current frame and the second frame may be the current frame.

For a selection of the first frame and the second frame, the process 300 may include performing a timestamp-based comparison of the number of frames with respect to a quality metric of each frame. Furthermore, each frame may be buffered with a timestamp associated with each of the number of frames. The process 300 may further include estimating a quality of each of the number of frames based on the timestamp-based comparison of the quality metric of each frame. The quality metric may be derived from a PSD of each frame and the first frame and the second frame may be selected amongst the number of frames based on the estimation.

For estimating the quality of each frame, the process 300 may include processing the number of frames by applying a number of Machine Learning (ML) techniques and calculating the PSD associated with each of the processed number of frames. The process 300 may also include selecting at least two frames amongst the number of frames with the PSD greater than a predetermined threshold based on a density-based clustering and an outlier elimination. The at least two frames may include the first frame and the second frame.

At operation 308, the process 300 may include determining a number of attributes associated with the one or more moving objects from at least one overlapping region of the first frame and the second frame. The determination may be performed by the determination engine 218 as referred in FIG. 2.

At operation 310, the process 300 may include correlating the number of attributes captured from the at least one overlapping region with a number of device attributes associated with a capturing device capturing the number of frames. The correlation may include changing a value of one or more attributes amongst the number of attributes with respect to a value of the number of device attributes. The correlation may be performed for normalizing the number of attributes by the normalizing engine as referred in FIG. 2.

Examples of the number of attributes may include, but are not limited to, one or more of a relative motion of the one or more moving objects, a ratio of swapping area of the one or more moving objects, a color of the one or more moving objects, a background color, a size of the one or more moving objects, a frame rate, a velocity of the one or more moving objects, and a time spent by the one or more moving objects in first frame. Examples of the number of device attributes may include, but are not limited to, one or more of a speed of the image capturing device, and a direction of a movement of the image capturing device. The normalization may include correlating the number of attributes with the number of device attributes.

At operation 312, the process 300 may include determining that the number of attributes upon being normalized move the one or more moving objects. The process 300 may further include detecting a direction of motion of the one or more moving objects in the first frame and the second frame. The step 312 may be performed by the trajectory determination engine 222 as referred in FIG. 2.

At operation 314, the process 300 may include generating a trajectory based on a down sampling and up sampling of the number of attributes by the trajectory determination engine 222. The trajectory may be determined for the one or more moving objects and a moving region of the one or more moving objects in the first frame and the second frame based on the normalized number of attributes.

At operation 316a, the process 300 may include stitching the first frame at a first location of the at least one overlapping region where the one or more object is present. The trajectory from the first frame is masked to regenerate a masked portion of the second frame. Operation 316a may be performed by the stitching engine 224 as referred in FIG. 2.

At operation 316b, the process 300 may include stitching the first frame at a second location of the at least one overlapping region where the one or more object is not present. The trajectory from the first frame may be masked to regenerate a masked portion of the second frame. Operation 316b may be performed by the stitching engine 224 as referred in FIG. 2.

At operation 318, the process 300 may include generating the stitched image by stitching the first frame with the masked portion of the second frame by the generation engine 226 as referred in FIG. 2.

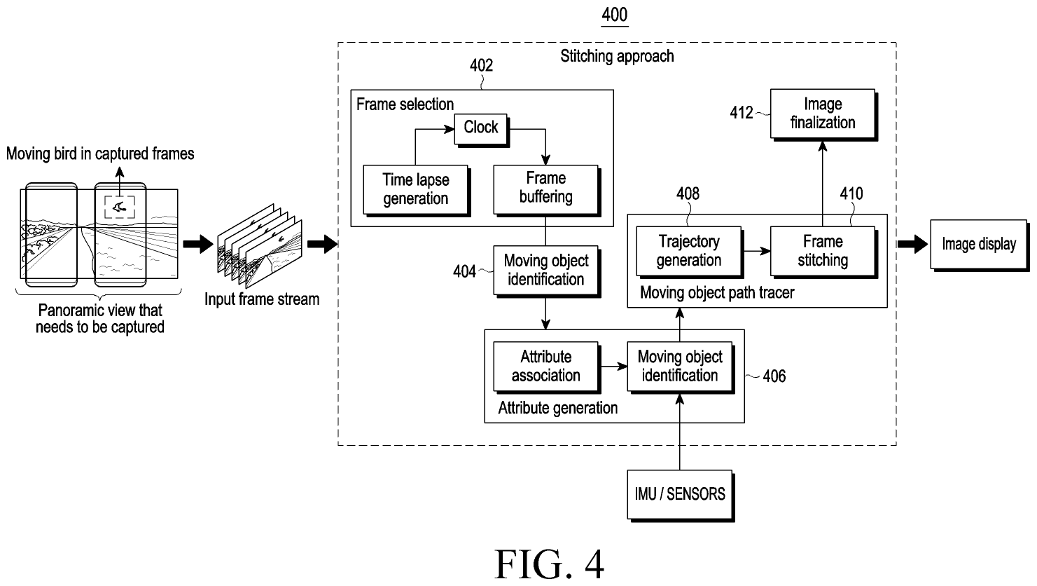

FIG. 4 is a diagram illustrating an example method 400 for generating a stitched image by stitching frames of an image comprising one or more moving objects, according to various embodiments. The method 400 may be performed by the system 202 incorporated in an electronic device.

At operation 402, the method 400 includes performing frame selection. A first frame and a second frame may be selected from an input stream of a frame sequence associated with a number of frames captured by an image capturing device. Examples of the image capturing device may include, but are not limited to, a camera, a video recorder, and a CCTV. In an embodiment, the number of frames may be buffered to compare a new frame with a previous frame. The first frame may be the previous frame with respect to the current frame and the second frame may be the current frame.

At operation 404, the method 400 may include identifying one or more moving objects from the first frame and the second frame and associated various time stamp for object movement within the first frame and the second frame. The identification may be performed based on comparing a number of second frame grids of the second frame with a number of first frame grids of the first frame in terms of a pixel intensity.

At operation 406, the method 400 may include determining a number of attributes associated with the one or more moving objects from at least one overlapping region of the first frame and the second frame. The determination may be performed by the determination engine 218 as referred in FIG. 2 via one or more sensors such as a motion sensor, and an IMU sensor. Further, the number of attributes captured from the at least one overlapping region may be correlated with a number of device attributes associated with a capturing device capturing the number of frames. The correlation may include changing a value of one or more attributes amongst the number of attributes with respect to a value of the number of device attributes. The correlation may be performed for normalizing the number of attributes by the normalizing engine as referred in FIG. 2. The normalization may include correlating the number of attributes with the number of device attributes.

At operation 408, the method 400 may include generating a trajectory based on a down sampling and up sampling of the number of attributes by the trajectory determination engine 222. The trajectory may be determined for the one or more moving objects and a moving region of the one or more moving objects in the first frame and the second frame based on the normalized number of attributes.

At operation 410, the method 400 may include performing one of a number of stitching techniques. The number of stitching techniques may include stitching the first frame at a first location of the at least one overlapping region where the one or more object is present. The trajectory from the first frame is masked to regenerate a masked portion of the second frame. The number of stitching techniques may further include stitching the first frame at a second location of the at least one overlapping region where the one or more object is not present. The trajectory from the first frame may be masked to regenerate a masked portion of the second frame.

At operation 412, the method 400 may include finalizing the stitched image by stitching the first frame with the masked portion of the second frame by the generation engine 226 as referred in FIG. 2.

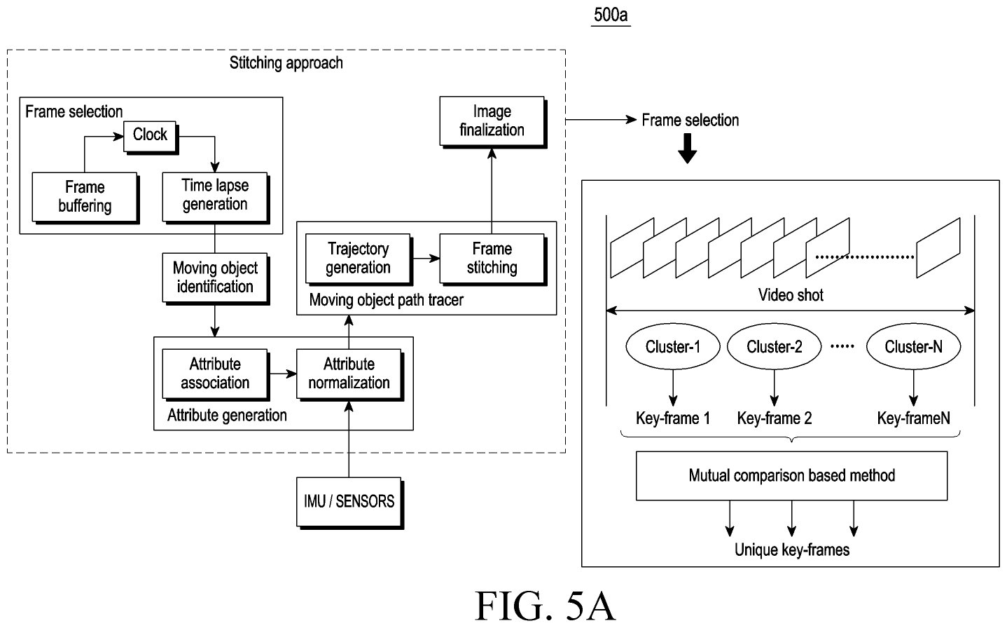

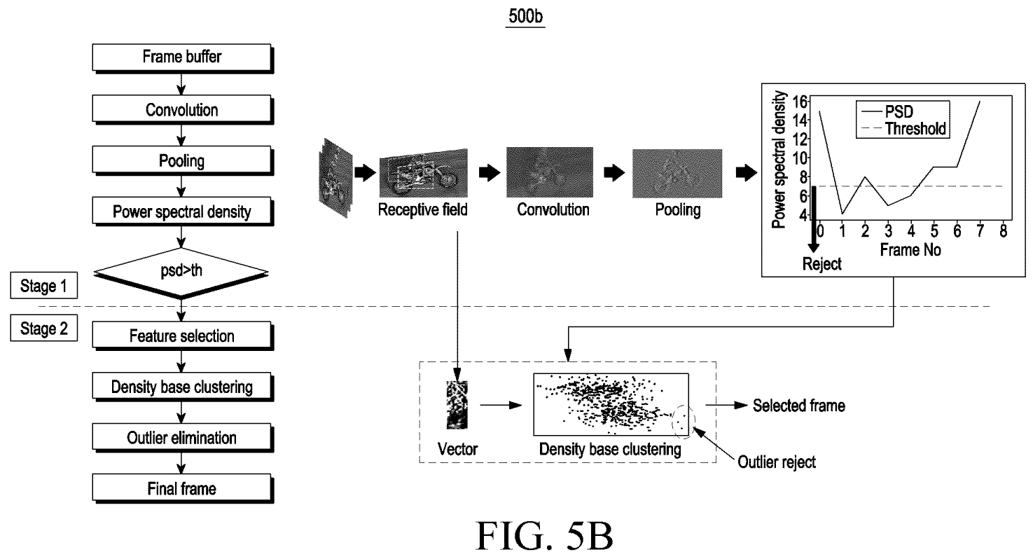

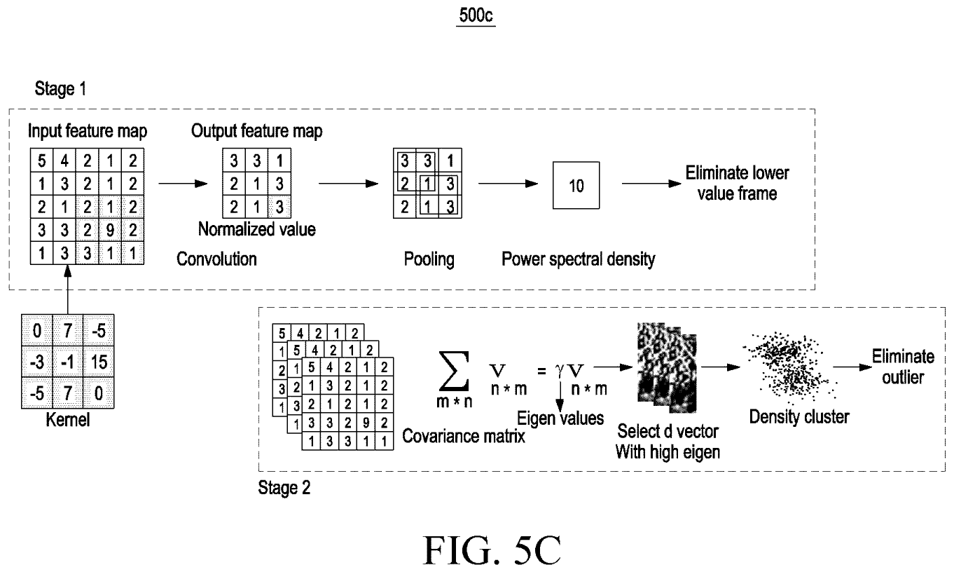

FIG. 5A is a diagram illustrating an example method 500a for selecting a first frame and a second frame from a number of frames, according to various embodiments. The method 500a may be performed by the capturing engine 214 as referred in FIG. 2. An individual quality metric of each frame from the number of frames may be determined for estimating a quality of each frame. Further, one or more distorted frames may be removed form the number of frames. Moving forward, remaining frames from the number of frames may be buffered with a time stamp for a time-based comparison of the remaining frames. Equation 1 mentioned below depicts the buffering.

$${F}_{n} = ( 1 - r ) {F}_{n} + {rF}_{0}$$

Fₙ is the new frame
F₀ is the old frame
r is the regulator value which regulates the rate at which foreground objects are deleted from background

An ‘N’ number of frames may be clustered into M clusters, such as, σ1, σ2, . . . , σM. The salient content of any object or a frame may be visual content of that object or a frame which could be color, texture or shape of the object or a frame. The similarity between two frames is determined by computing the similarity of the visual content.

FIG. 5B is a diagram illustrating an example process 500b for selecting the first frame and the second frame from the number of frames, according to various embodiments.

The process 500b includes performing a frame buffer as disclosed in FIG. 5A and proceeding to performing pooling and convolution on the number of frames. Based on the performing the frame buffer, the pooling, and the convolution, a quality of each of the number of frames may be estimated. The pooling may be performed to reduce a number of parameters to learn, and an amount of computation performed in a network. The convolution may be an element wise matrix multiplication of kernel (filter) with an image pixel. The quality metric may be derived from a Power Spectral Density (PSD) of each frame. Further, one or more frames may be selected and based on a determination that the PSD associated with the one or more frames is greater than a predetermined threshold. Upon selection of the one or more frame, a density base clustering may be performed for an outlier detection and elimination. Based on that, the first frame and the second frame may be selected.

FIG. 5C is a diagram 500c illustrating an example first stage and second stage for selecting the first frame and the second frame, according to various embodiments. The first stage may include performing the pooling, the convolution, determining the PSD and eliminating lower value frames from the number of frames. The second stage may include performing the density base clustering for the outlier detection and elimination. Based on that, the first frame and the second frame may be selected.

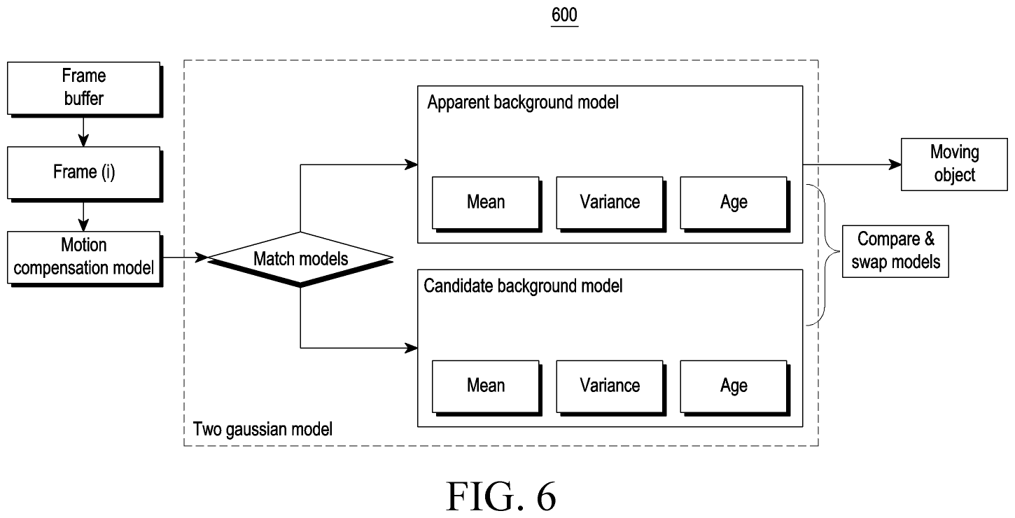

FIG. 6 is a diagram illustrating an example process 600 for identifying one or more moving objects in a number of frames, according to various embodiments. The one or more moving objects may be identified from a first frame and a second frame amongst the number of frames. The process 600 may be performed by the identification engine 216 as referred in FIG. 2.

The model learned until time t−1 cannot be used directly for detection in time t. To use the model, motion compensation is required. A compensated background model for motion compensation at time t by merging the statistics of the model at time t−1 may be constructed. A single gaussian model with age may use a gaussian distribution to keep track of the change of the moving background.

If the age of a candidate background model becomes larger than an apparent background model, the models may be swapped and correct background models may be used. The candidate background model may remain ineffective until the age becomes older than the apparent background model, when, at that time, the two models may be swapped.

If in a new frame, pixel intensities in a specific grid are not matching with a corresponding grid in previous frames, it may be concluded that there is a moving object in the grid. Parameters with tilde may refer to the parameter values of the corresponding grid in the previous frames. Due to motion, background may be changing so the grid may be matched in different frames. The identification of the one or more frames may be depicted in equation 2 below:

$${μ}_{i}^{( t )} = \frac{{\tilde{a}}_{i}^{( t - 1 )}}{{\tilde{a}}_{i}^{( t - 1 )} + 1} {\tilde{μ}}_{i}^{( t - 1 )} + \frac{1}{{\tilde{a}}_{i}^{( t - 1 )} + 1} {M}_{i}^{( t )}$$

$${σ}_{i}^{( t )} = \frac{{\tilde{a}}_{i}^{( t - 1 )}}{{\tilde{a}}_{i}^{( t - 1 )} + 1} {\tilde{σ}}_{i}^{( t - 1 )} + \frac{1}{{\tilde{a}}_{i}^{( t - 1 )} + 1} {V}_{i}^{( t )}$$

$${α}_{i}^{( t )} = \vert {\tilde{α}}_{i}^{( t - 1 )} + 1$$

Where M and V are the mean and variance of all pixels in grid i, i is the age of the grid i, referring to the number of consecutive frames this grid is shown.

Motion Compensation may be used to match grids in consecutive frames as the background may be moving in different frames.

For all grids G(3224) in time stamp t, the process 600 may include first performing the Kanade-Lucas-Tomasi Feature Tracker (KLT) on corners of each grid G(t) I to extract features of the points, further RANSAC[2] may be performed to generate transformation matrix H^{(t,t-1)} frame at t to t−1.

For each grid the process 600 may include finding the matching grid Gᵢ^{(t-1)} by H_{(t,t-1)} by and applies a weighted summation for grids in frame t−1 that Gᵢ^{(t-1)} i covers to generate the parameter values of Gᵢ^{(t-1)}.

$${G}_{i}^{( t - 1 )} = SGM ( {\tilde{μ}}_{i}^{( t - 1 )} , {\tilde{σ}}_{i}^{( t - 1 )} , {\tilde{α}}_{i}^{( t - 1 )} )$$

For each grid keep track of two SGM B and F and each time only update one model. We start from updating B (assume it as the background model), until

$${( {M}_{i}^{( t )} - {μ}_{B , i}^{( t )} )}^{2} >= {θ}_{s} {σ}_{B , i}^{( t )}$$

Where s is a threshold parameter. Then update F, similarly until

$${( {M}_{i}^{( t )} - {μ}_{F , i}^{( t )} )}^{2} >= {θ}_{s} {σ}_{F , i}^{( t )}$$

Further, the model may be swapped for recording foreground and background model if the number of consecutive updates of F is larger than that of B, that is

α_{F,i}^{(t)}>α_{B,i}^{(t)}

Swapping may be performed if the “foreground” stay longer in frames than “background” than the foreground is probably the real background. M and V may be the mean and variance of all pixels in grid i, αᵢ age of the grid i.

The model swapping may include a SGM (Single Gaussian Model) that may be configured to keeps track of change of moving background, if in a new frame pixel intensity in a grid are different comparing corresponding grid in previous frame then it has a moving object. Two SGMs may be used to record the grid related to background and foreground (moving objects) separately such that the pixel intensities in foreground may not contaminate the parameter values in the background Gaussian model.

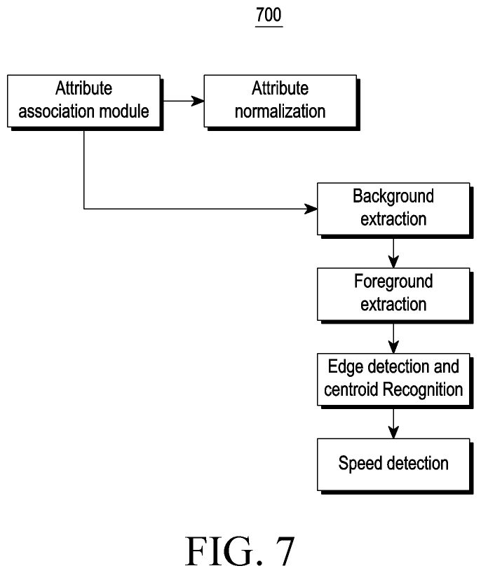

FIG. 7 is a diagram illustrating an example process 700 for determining a number of attributes of one or more moving objects, according to various embodiments. The one or more moving objects may be present in a number of frames. Examples of the number attributes may be include, but are not limited to, one or more of a relative motion of the one or more moving objects, a ratio of swapping area of the one or more moving objects, a color of the one or more moving objects, a background color, a size of the one or more moving objects, a frame rate, a velocity of the one or more moving objects, and a time spent by the one or more moving objects in the first frame. The number of attributes may be determined based on a background extraction, a foreground extraction, and edge detection and centroid recognition, and a speed detection.

The background extraction, the foreground extraction, and the speed detection may be performed based on the equations 3, 4, and 5, as mentioned below. After foreground extraction, the collected images may be transferred to binary image as the operations such as edge detection, noise and dilation removal and object labeling are suitable in binary platform. The speed of the moving object in each frame is calculated using the position of the vehicle in each frame If pixel has the coordinate. i=(a,b) i−1=(e, f), where the centroids location is showed in frame i and i−1 for object, with (a, b) coordinate and (e, f) coordinate.

$${k}_{xy} ( {t}_{n} ) = \frac{{\sum }_{m = 0}^{j - 1} {f}_{xy} ( {t}_{n - m} )}{j}$$

Where: n is frame number
F_{xy}(tₙ) is the pixel value of (x,y) in n'th frame;
k_{xy}(tₙ) is the pixel mean value of (x,y) in n'th frame averaged over the previous j frames, and j is the number of the frames used to calculate the average of the pixels value.

$${N}_{xy} ( {t}_{n} ) = \{ \begin{matrix}1 & Foreground \vert {f}_{xy} ( {t}_{n} ) - {f}_{xy} ( {t}_{n - 1} ) \vert > T \\ 0 & Background \vert {f}_{xy} ( {t}_{n} ) - {f}_{xy} ( {t}_{n - 1} ) \vert < T\end{matrix}$$

Where Nxy(tn) is the value of the foreground or background of the picture at pixel (x, y) in n'th frame
T is the threshold used to distinguish between the foreground and background.

$${d}_{i} = \sqrt{{( a - e )}^{i} + {( b - f )}^{i}} V = K \frac{Δ x}{Δ t}$$

K is the calibration coefficient

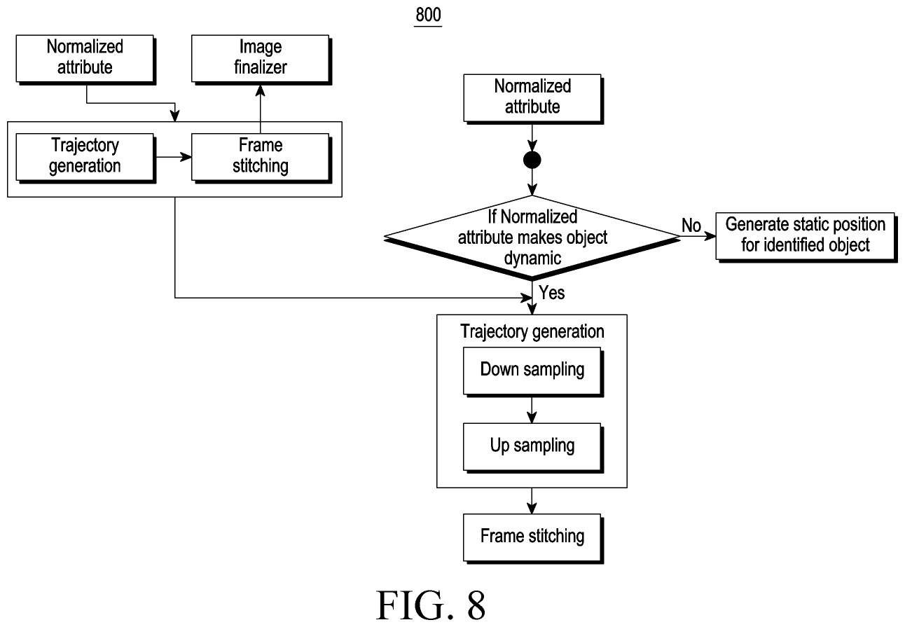

FIG. 8 is a flowchart illustrating an example process 800 for tracing a path of one or more moving objects, according to various embodiments. The process 800 may include determining whether normalized attributes of the one or more moving objects make the one or more moving objects dynamic. In an embodiment, where it is determined that the one or more moving objects are not dynamic, a static position for identified object may be generated. In an embodiment, where it is determined that the one or more moving objects are dynamic, the process 800 may include performing a trajectory generation and a frame stitching. The path tracing may be depicted in eq. 6 mentioned below. For each pixel move (u, v) constant within in small neighborhood w

$$Δ d \to small$$

$$Point ( i , j ) ∈ w : {I}_{x} ( i , j ) u + {I}_{y} ( i , j ) v + {I}_{t} ( i , j ) = 0$$

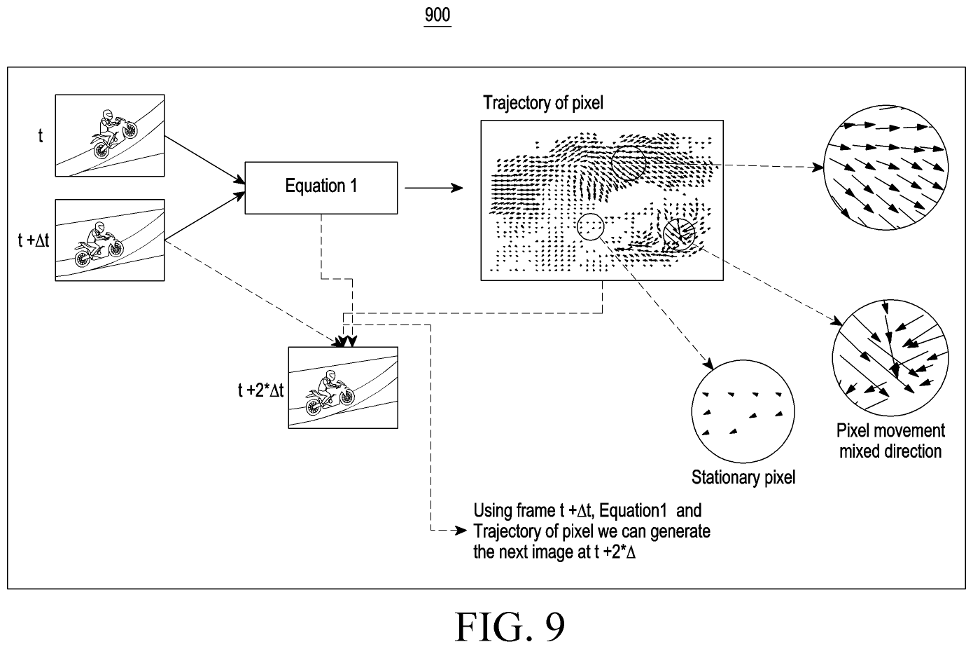

FIG. 9 is a diagram 900 illustrating example trajectory generation, according to various embodiments. The trajectory generation may be performed by the trajectory determination engine 222 as referred in FIG. 2. Further, the trajectory generation may include a down sampling, and an up sampling. The down sampling may be utilised to reduce a dimension and get most pure feature-taking high dimensional data and project into low dimension. The up sampling may be utilized to increase the dimension taking low dimensional data and try to reconstruct the original frame. Trajectory generation may utilise the eq. 6 as referred in FIG. 9 to calculate a velocity in y direction and x direction by taking two frames. Using frame t+Δt, eq. 6 and a trajectory of pixel a next image at t+2*Δ may be generated.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for generating a stitched image by an electronic device, the method comprising:
obtaining an input stream including a plurality of frames through an image capturing device;
identifying one or more moving objects and one or more timestamps associated with movement of the one or more moving objects from a first frame and a second frame selected among the plurality of frames;
determining a plurality of attributes associated with the one or more moving objects from at least one overlapping region of the first frame and the second frame;
normalizing the determined plurality of attributes with respect to a plurality of device attributes associated with the image capturing device;
determining a trajectory, associated with the one or more moving objects and a moving region of the one or more moving objects in the first frame and the second frame based on the normalized plurality of attributes;
performing one of:
stitching the first frame at a first location of the at least one overlapping region where the one or more moving objects are present, wherein the trajectory from the first frame is masked to regenerate a masked portion of the second frame, and
stitching the first frame at a second location of the at least one overlapping region where the one or more moving objects are not present, wherein the trajectory from the first frame is masked to regenerate a masked portion of the second frame; and
generating the stitched image by stitching the first frame with the masked portion of the second frame.

2. The method of claim 1, wherein the first frame includes a previous frame with respect to a current frame and the second frame includes the current frame.

3. The method of claim 1, wherein the plurality of attributes comprises one or more of a relative motion of the one or more moving objects, a ratio of swapping area of the one or more moving objects, a color of the one or more moving objects, a background color, a size of the one or more moving objects, a frame rate, a velocity of the one or more moving objects, and a time spent by the one or more moving objects in first frame and the plurality of device attributes comprises one or more of a speed of the image capturing device, and a direction of a movement of the image capturing device.

4. The method of claim 1, further comprising:
performing a timestamp-based comparison of the plurality of frames with respect to a quality metric of each frame, wherein each of the plurality of frame is buffered with a timestamp associated with a corresponding frame;
estimating a quality of each of the plurality of frames based on the timestamp-based comparison of the quality metric of each frame, wherein the quality metric is derived from a Power Spectral Density (PSD) of each of the plurality of frames; and
selecting the first frame and the second frame among the plurality of frames based on the estimation.

5. The method of claim 4, wherein estimating the quality of each frame comprises:
processing the plurality of frames by applying a plurality of Machine Learning (ML) techniques;
calculating the PSD associated with each of the processed plurality of frames; and
selecting at least two frames among the plurality of frames with the PSD greater than a specified threshold based on a density-based clustering and an outlier elimination, wherein the at least two frames comprise the first frame and the second frame.

6. The method of claim 1, wherein identifying the one or more moving objects comprises:
comparing a plurality of second frame grids of the second frame with a plurality of first frame grids of the first frame in terms of a pixel intensity, wherein the pixel intensity is associated with the plurality of second frame grids and the plurality of first frame grids;
determining that the pixel intensity associated with the plurality of second frame grids does not match the pixel intensity associated with the plurality of first frame grids; and
identifying the one or more moving objects in the first frame and second frame based on the determining.

7. The method of claim 1, wherein determining the trajectory of the one or more moving objects and the moving region of the one or more moving objects comprises:
determining that the plurality of attributes upon being normalized move the one or more moving objects;
detecting a direction of motion of the one or more moving objects in the first frame and the second frame; and
generating the trajectory based on a down sampling and up sampling of the plurality of attributes.

8. The method of claim 1, wherein normalizing the determined plurality of attributes with respect to the plurality of device attributes comprises correlating the plurality of attributes with the plurality of device attributes.

9. The method of claim 8, wherein correlating the plurality of attributes with the plurality of device attributes comprises changing a value of one or more attributes amongst the plurality of attributes with respect to a value of the plurality of device attributes.

10. An electronic device configured to generate a stitched image, the electronic device comprising:
memory storing instructions; and
at least one processor, comprising processing circuitry, coupled to the memory, wherein the instructions, when executed by the at least one processor, cause the electronic device to:
obtain an input stream including a plurality of frames through an image capturing device;
identify one or more moving objects and one or more timestamps associated with movement of the one or more moving objects from a first frame and a second frame selected among the plurality of frames;
determine a plurality of attributes associated with the one or more moving objects from at least one overlapping region of the first frame and the second frame;
normalize the determined plurality of attributes with respect to a plurality of device attributes associated with the image capturing device;
determine a trajectory, associated with the one or more moving objects and a moving region of the one or more moving objects in the first frame and the second frame based on the normalized plurality of attributes;
perform one of:
stitching the first frame at a first location of the at least one overlapping region where the one or more moving objects are present, wherein the trajectory from the first frame is masked to regenerate a masked portion of the second frame, and
stitching the first frame at a second location of the at least one overlapping region where the one or more moving objects are not present, wherein the trajectory from the first frame is masked to regenerate a masked portion of the second frame; and
generate the stitched image by stitching the first frame with the masked portion of the second frame.

11. The electronic device of claim 10, wherein the first frame includes a previous frame with respect to a current frame and the second frame includes the current frame.

12. The electronic device of claim 10, wherein the plurality of attributes comprises one or more of a relative motion of the one or more moving objects, a ratio of swapping area of the one or more moving objects, a color of the one or more moving objects, a background color, a size of the one or more moving objects, a frame rate, a velocity of the one or more moving objects, and a time spent by the one or more moving objects in first frame and the plurality of device attributes comprises one or more of a speed of the image capturing device, and a direction of a movement of the image capturing device.

13. The electronic device of claim 10, wherein the instructions, when executed by the at least one processor, cause the electronic device further to:
perform a timestamp-based comparison of the plurality of frames with respect to a quality metric of each frame, wherein each of the plurality of frame is buffered with a timestamp associated with a corresponding frame;
estimate a quality of each of the plurality of frames based on the timestamp-based comparison of the quality metric of each frame, wherein the quality metric is derived from a Power Spectral Density (PSD) of each of the plurality of frames; and
select the first frame and the second frame among the plurality of frames based on the estimation.

14. The electronic device of claim 13, wherein to estimate the quality of each frame, the instructions, when executed by the at least one processor, cause the electronic device to:
process the plurality of frames by applying a plurality of Machine Learning (ML) techniques;
calculate the PSD associated with each of the processed plurality of frames; and
select at least two frames among the plurality of frames with the PSD greater than a specified threshold based on a density-based clustering and an outlier elimination, wherein the at least two frames comprise the first frame and the second frame.

15. The electronic device of claim 10, wherein to identify the one or more moving objects, the instructions, when executed by the at least one processor, cause the electronic device to:
compare a plurality of second frame grids of the second frame with a plurality of first frame grids of the first frame in terms of a pixel intensity, wherein the pixel intensity is associated with the plurality of second frame grids and the plurality of first frame grids;
determine that the pixel intensity associated with the plurality of second frame grids does not match the pixel intensity associated with the plurality of first frame grids; and
identify the one or more moving objects in the first frame and second frame based on the determining.

16. The electronic device of claim 10, wherein to determine the trajectory of the one or more moving objects and the moving region of the one or more moving objects, the instructions, when executed by the at least one processor, cause the electronic device to:
determine that the plurality of attributes upon being normalized move the one or more moving objects;
detect a direction of motion of the one or more moving objects in the first frame and the second frame; and
generate the trajectory based on a down sampling and up sampling of the plurality of attributes.

17. The electronic device of claim 10, wherein to normalize the determined plurality of attributes with respect to the plurality of device attributes, the instructions, when executed by the at least one processor, cause the electronic device to correlate the plurality of attributes with the plurality of device attributes.

18. The electronic device of claim 17, wherein to correlate the plurality of attributes with the plurality of device attributes, the instructions, when executed by the at least one processor, cause the electronic device to change a value of one or more attributes amongst the plurality of attributes with respect to a value of the plurality of device attributes.

19. A non-transitory computer-readable storage medium storing instructions which, when executed by at least one processor of an electronic device, cause the electronic device to perform operations comprising:
obtaining an input stream including a plurality of frames through an image capturing device;
identifying one or more moving objects and one or more timestamps associated with movement of the one or more moving objects from a first frame and a second frame selected among the plurality of frames;
determining a plurality of attributes associated with the one or more moving objects from at least one overlapping region of the first frame and the second frame;
normalizing the determined plurality of attributes with respect to a plurality of device attributes associated with the image capturing device;
determining a trajectory, associated with the one or more moving objects and a moving region of the one or more moving objects in the first frame and the second frame based on the normalized plurality of attributes;
performing one of:
stitching the first frame at a first location of the at least one overlapping region where the one or more moving objects are present, wherein the trajectory from the first frame is masked to regenerate a masked portion of the second frame, and
stitching the first frame at a second location of the at least one overlapping region where the one or more moving objects are not present, wherein the trajectory from the first frame is masked to regenerate a masked portion of the second frame; and
generating the stitched image by stitching the first frame with the masked portion of the second frame.

20. The non-transitory computer-readable storage medium of claim 19, wherein the first frame includes a previous frame with respect to a current frame and the second frame includes the current frame.
